(19) United States
(12) Patent Application Publication
(10) Pub. No.: US 2026/0214379 A1
(43) Pub. Date: Jul. 23, 2026

(54) MULTIFUNCTIONAL SOUND-GENERATING DEVICE

(71) Applicant: AAC Microtech (Changzhou) Co., Ltd., Changzhou City (CN)

(72) Inventors: Zhiwei Zhong, Changzhou (CN); Wei Song, Changzhou (CN); Xin Jin, Changzhou (CN); Fan Zhang, Changzhou (CN); Yun Tang, Changzhou (CN)

(21) Appl. No.: 19/325,476

(22) Filed: Sep. 10, 2025

Related U.S. Application Data
(63) Continuation of application No. PCT/CN2025/074052, filed on Jan. 22, 2025.

(51) Int. Cl. H04R 1/28; H04R 1/02; H04R 9/02; H04R 9/04; H04R 9/06

(52) U.S. Cl. CPC H04R 1/2896; H04R 1/025; H04R 9/025; H04R 9/045; H04R 9/06; H04R 2400/11

(57) ABSTRACT

A multifunctional sound-generating device is provided according to the present disclosure, which includes a housing with an accommodating space, a sound-generating unit accommodated in the accommodating space, and a drive coil elastically supported in the accommodating space. The sound-generating unit includes a basket fixed to the housing, a vibration system and a magnetic circuit system respectively located on two opposite sides of the basket, and the magnetic circuit system is configured to drive the vibration system to vibrate and generate sound. The drive coil is spaced apart from the magnetic circuit system and located within a magnetic field range of the magnetic circuit system. The magnetic circuit system is spaced apart from the housing, and the multifunctional sound-generating device further includes a first elastic member elastically supporting the magnetic circuit system to the basket.

### CROSS REFERENCE TO RELATED APPLICATIONS

The present application is a continuation of PCT Patent Application No. PCT/CN2025/074052, filed January 22, 2025, which is incorporated by reference herein in its entirety.

### TECHNICAL FIELD

The present disclosure relates to the technical field of electro-acoustic conversion, and in particular to a multifunctional sound-generating device.

### BACKGROUND

With the continuous innovation of small mobile devices, the small mobile devices are increasingly favored by users. The most common small mobile devices include mobile phones, tablets, and handheld game machines. Moreover, the playback function and vibration function in small mobile devices have become basic functions. Therefore, multifunctional sound-generating devices that have both playback and vibration functions are now widely used in small mobile devices.

A multifunctional sound-generating device mainly includes a housing, a sound-generating unit and a drive coil respectively fixed in the housing. The sound-generating unit includes a basket fixed in the housing, a vibration system and a magnetic circuit system for driving the vibration system to vibrate, and the vibration system and the magnetic circuit system are respectively fixed to the basket. The magnetic circuit system is configured to drive the vibration system to vibrate, and the drive coil is spaced apart from the magnetic circuit system.

In the related technology, since the magnetic circuit system of the multifunctional sound-generating device needs to be fixed to the basket, when the vibration system vibrates, it will not be subjected to any force that can be offset. In this case, the basket of the multifunctional sound-generating device and the entire machine connected with the basket vibrate strongly, which leads to a strong vibration feeling during holding or touching the entire machine, thereby ultimately leading to a poor user experience.

### SUMMARY

An object according to the present disclosure is to provide a multifunctional sound-generating device to solve the problem in related technology that the basket of the multifunctional sound-generating device and the entire machine connected with the basket vibrate strongly, which leads to a strong vibration feeling during holding or touching the entire machine, thereby ultimately leading to a poor user experience.

In order to achieve the above object, a multifunctional sound-generating device is provided, which includes a housing with an accommodating space, a sound-generating unit accommodated in the accommodating space, and a drive coil elastically supported in the accommodating space. The sound-generating unit includes a basket fixed to the housing, a vibration system and a magnetic circuit system respectively located on two opposite sides of the basket. The magnetic circuit system is configured to drive the vibration system to vibrate and generate sound, the vibration system vibrates along a first direction, the drive coil is spaced apart from the magnetic circuit system and located within a magnetic field range of the magnetic circuit system, and the drive coil interacts with the magnetic circuit system to drive the drive coil to move in a plane perpendicular to the first direction.

The magnetic circuit system is spaced apart from the housing, where the multifunctional sound-generating device further includes a first elastic member elastically supporting the magnetic circuit system to the basket, the first elastic member elastically supports the magnetic circuit system to move along the first direction, and a moving direction of the magnetic circuit system and a moving direction of the vibration system are opposite to each other or away from each other.

As an improvement, the first elastic member is made of silicone rubber material or foam material.

As an improvement, the first elastic member is block-shaped, arc-shaped, or bent.

As an improvement, the magnetic circuit system includes a lower clamping plate, a main magnetic portion stacked and fixed to the lower clamping plate, and an auxiliary magnetic portion stacked and fixed to the lower clamping plate and spaced apart from the main magnetic portion, where the first elastic member is fixed between the auxiliary magnetic portion and the basket.

As an improvement, the multifunctional sound-generating device further includes a fixing member connecting the basket with the first elastic member, where the fixing member includes a supporting portion fixed to the basket and a bent portion formed by bending and extending from an end of the supporting portion close to the first elastic member, and the first elastic member is clamped and fixed between the auxiliary magnetic portion and the bent portion.

As an improvement, at least two fixing members are provided, the multifunctional sound-generating device further includes a connecting member connecting adjacent fixing members, the connecting member and at least two fixing members form an annular structure, and the magnetic circuit system is arranged in the annular structure.

As an improvement, the multifunctional sound-generating device further includes a first elastic gasket clamped and fixed between a side of the magnetic circuit system away from the vibration system and a side of the housing close to the magnetic circuit system.

As an improvement, the multifunctional sound-generating device further includes a second elastic gasket clamped and fixed between a side of the vibration system away from the magnetic circuit system and a side of the housing close to the vibration system.

As an improvement, the multifunctional sound-generating device further includes a second elastic member elastically supporting the drive coil, where the second elastic member includes two fixed arms fixed to two opposite sides of the housing, a bottom plate suspended on a side of the magnetic circuit system away from the vibration system, and two elastic arms respectively extending from the two fixed arms toward two opposite sides of the bottom plate and fixedly connected with the bottom plate, the bottom plate is spaced apart from the magnetic circuit system along the first direction, and the drive coil is fixed to the bottom plate and arranged opposite to and spaced apart from the magnetic circuit system.

As an improvement, the multifunctional sound-generating device further includes a mass block fixed to a side of the bottom plate close to the magnetic circuit system, and the mass block is spaced apart from the housing, the basket and the magnetic circuit system.

Compared with the related technology, the multifunctional sound-generating device according to the present disclosure elastically supports the magnetic circuit system on the basket by the first elastic member, and limits the moving direction of the magnetic circuit system and the moving direction of the vibration system to be opposite to or away from each other. In this way, when the vibration system vibrates, the bass vibration of the vibration system can be offset by the vibration of the magnetic circuit system, thereby reducing the vibration of the basket and the entire machine connected with the basket, weakening the vibration feeling during holding or touching the entire machine, and further improving the user experience.

### BRIEF DESCRIPTION OF THE DRAWINGS

In order to explain the technical solution of the present disclosure more clearly, a brief description will be given to the accompanying drawings required for the description of the embodiments. Obviously, the drawings in the following description are only some embodiments of the present disclosure, and other drawings can be obtained by those skilled in the art according to these drawings without creative efforts.

FIG. 1 is a schematic perspective view of a multifunctional sound-generating device according to an embodiment of the present disclosure.

FIG. 2 is a partially exploded view of the multifunctional sound-generating device according to an embodiment of the present disclosure.

FIG. 3 is a cross-sectional view of the multifunctional sound-generating device taken along line A-A in FIG. 1.

FIG. 4 is a cross-sectional view of the multifunctional sound-generating device taken along line B-B in FIG. 1.

### Reference numerals are listed as follows:

100, multifunctional sound-generating device;

1, housing;

11, upper cover; 111, sound guiding channel;

112, supporting wall; 12, lower cover;

2, sound-generating unit; 21, basket;

22, vibration system; 221, diaphragm;

2211, first folding ring; 2212, second folding ring;

2213, first fixing portion; 2214, vibration portion;

2215, second fixing portion; 222, voice coil;

223, elastic supporting member; 2231, first flexible circuit board;

224, skeleton; 23, magnetic circuit system;

231, lower clamping plate; 232, main magnetic portion;

2321, main magnet; 2322, upper clamping plate;

2323, central magnet; 233, auxiliary magnetic portion;

2331, auxiliary magnet; 2332, magnetic conduction plate;

3, drive coil; 31, second flexible circuit board;

4, first elastic member; 5, fixing member;

51, supporting portion; 52, bent portion;

53, connecting member; 6, first elastic gasket;

7, second elastic gasket; 8, second elastic member;

81, fixed arm; 82, bottom plate;

83, elastic arm; 9, mass block;

10, front cavity; 20, front acoustic cavity;

30, rear cavity.

### DETAILED DESCRIPTION OF THE EMBODIMENTS

In the following, the technical solution in the present disclosure will be clearly and completely described with reference to the attached drawings. Obviously, the described embodiment is only a part of the embodiments of the present disclosure, not all the embodiments. Based on the embodiments in the present disclosure, all other embodiments obtained by those skilled in the art without creative efforts fall within the protection scope of the present disclosure.

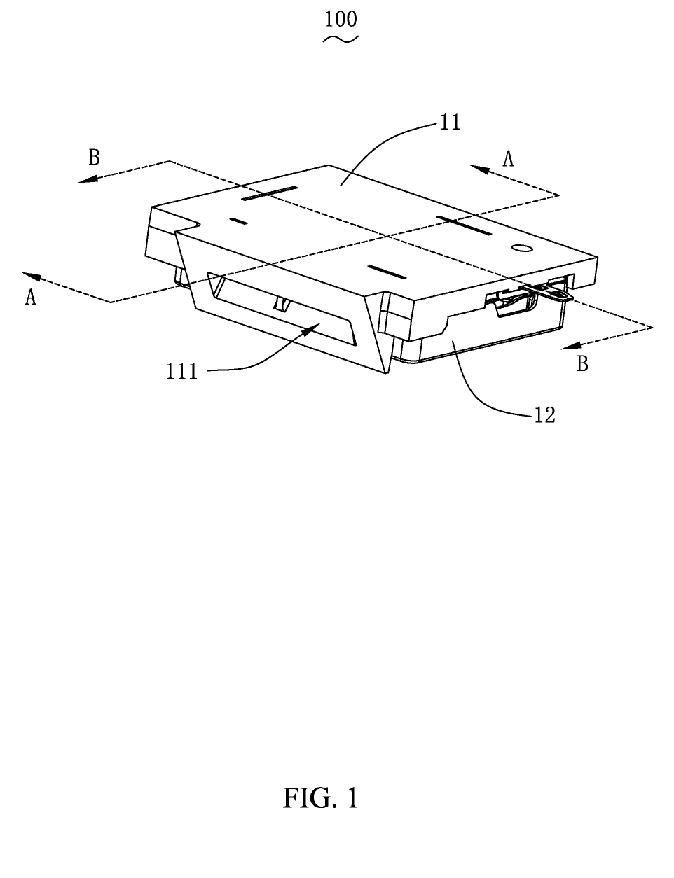

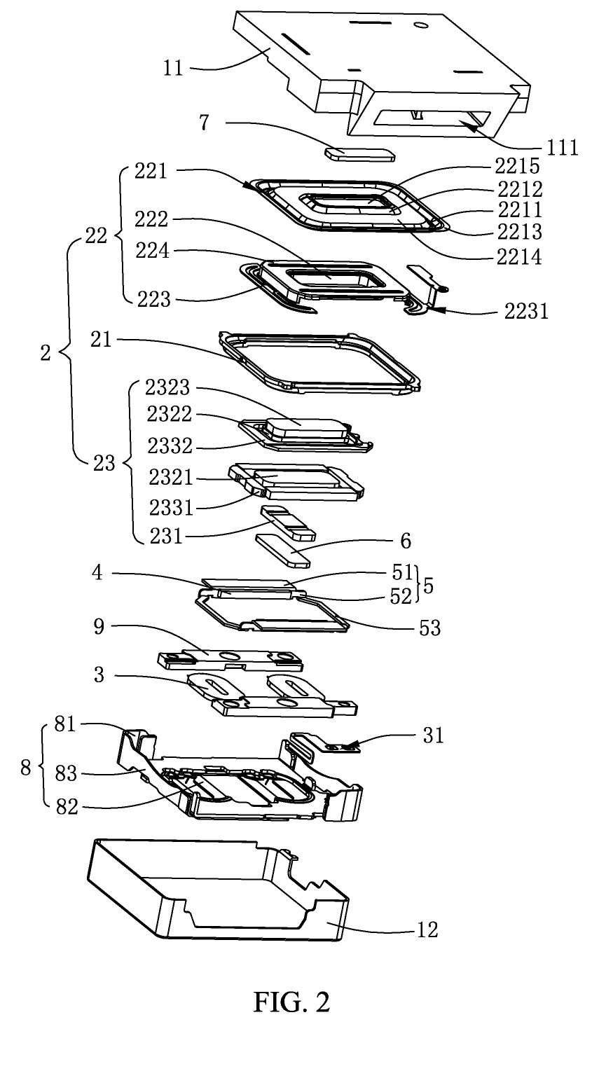

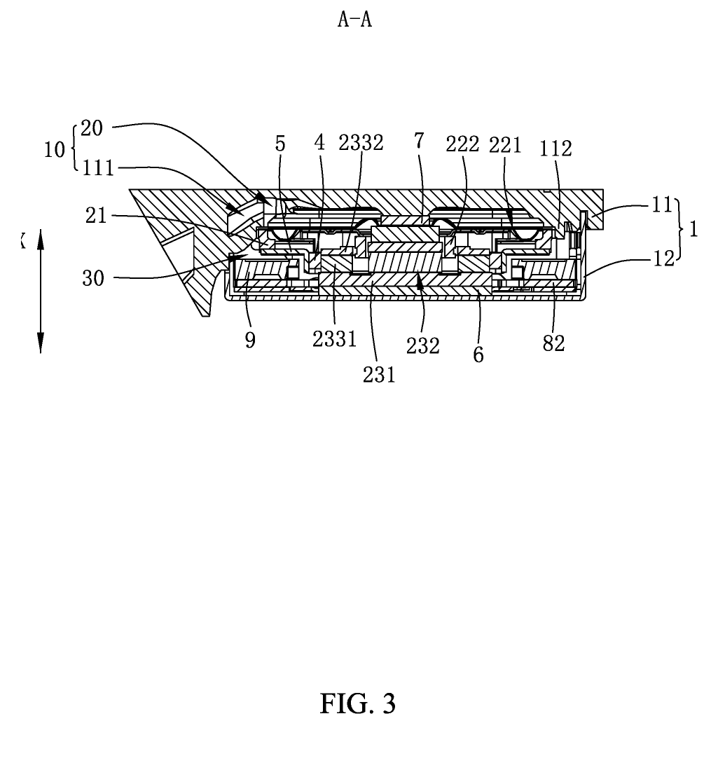

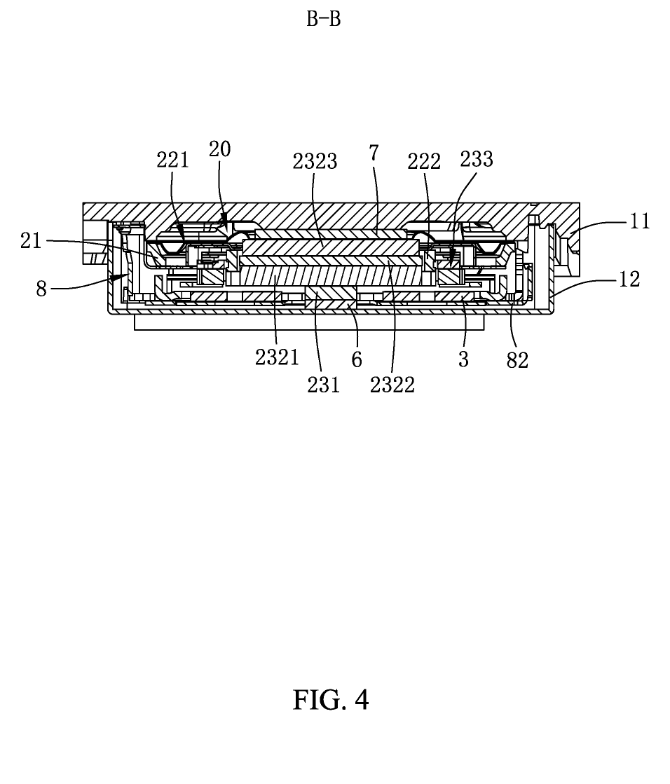

A multifunctional sound-generating device 100 is provided according to the present disclosure, referring to FIG. 1 to FIG. 4, which includes a housing 1 with an accommodating space, a sound-generating unit 2 accommodated in the accommodating space, and a drive coil 3 elastically supported in the accommodating space;

The multifunctional sound-generating device 100 is rectangular. According to actual needs, the multifunctional sound-generating device 100 can further be designed into other shapes, such as circular, trapezoidal, oval, etc.

The housing includes an upper cover 11 and a lower cover 12 engaged with the upper cover 11, and the upper cover 11 and the lower cover 12 jointly enclose an accommodating space.

The sound-generating unit 2 and the upper cover 11 are spaced apart and jointly enclose a front acoustic cavity 20. The upper cover 11 is provided with a sound guiding channel 111 extending through the upper cover 11, and the sound guiding channel 111 communicates the front acoustic cavity 20 with an exterior environment and jointly forms a front cavity 10 together with the front acoustic cavity 20. The sound-generating unit 2, the upper cover 11 and the lower cover 12 jointly enclose a rear cavity 30.

The sound-generating unit 2 includes a basket 21 fixed to the housing 1, a vibration system 22 and a magnetic circuit system 23 respectively located on two opposite sides of the basket 21. The magnetic circuit system 23 is spaced apart from the housing 1, the magnetic circuit system 23 is configured to drive the vibration system 22 to vibrate and generate sound, and the vibration system 22 vibrates along a first direction X. The drive coil 3 is spaced apart from the magnetic circuit system 23 and located within a magnetic field range of the magnetic circuit system 23, and the drive coil 3 interacts with the magnetic circuit system 23 to drive the drive coil 3 to move in a plane perpendicular to the first direction X.

The upper cover 11 is provided with a supporting wall 112 extending toward the lower cover 12, and the basket 21 is fixed to the supporting wall.

The vibration system 22 includes a diaphragm 221 fixed to a side of the basket 21 away from the magnetic circuit system 23, and a voice coil 222 fixed to a side of the diaphragm 221 close to the magnetic circuit system 23 and configured to drive the diaphragm 221 to vibrate and generate sound.

In this embodiment, the diaphragm 221 includes a first folding ring 2211 and a second folding ring 2212 which are annular and spaced apart from each other, a first fixing portion 2213 extending from an outer peripheral edge of the first folding ring 2211 toward the basket 21 and fixed to the basket 21, a vibration portion 2214 extending from an inner peripheral edge of the first folding ring 2211 toward the second folding ring 2212 and fixed to an outer peripheral edge of the second folding ring 2212, and a second fixing portion 2215 fixedly connected to an inner peripheral edge of the second folding ring 2212.

The vibration system 22 further includes elastic supporting members 223 and an annular skeleton 224. Two elastic supporting members 223 are provided and are respectively arranged on two opposite sides of the basket 21. The elastic supporting members 223 serve as a first flexible circuit board 2231 and are electrically connected with the voice coil 222. One end of each elastic supporting member 223 is fixed to the basket 21, and the other end is fixed to the skeleton 224. The skeleton 224 is attached and fixed to the vibration portion 2214 of the diaphragm 221, and an inner side of the skeleton 224 extends toward the voice coil 222 and is fixedly connected with the voice coil 222.

The magnetic circuit system 23 includes a lower clamping plate 231, a main magnetic portion 232 stacked and fixed to the lower clamping plate 231, and an auxiliary magnetic portion 233 stacked and fixed to the lower clamping plate 231 and spaced apart from the main magnetic portion 232. The drive coil 3 is respectively opposite to and spaced apart from the main magnetic portion 232 and the auxiliary magnetic portion 233 in the first direction X, and the first elastic member 4 is fixed between the auxiliary magnetic portion 233 and the basket 21. A magnetic gap is formed between the auxiliary magnetic portion 233 and the main magnetic portion 232, and the voice coil 222 is inserted and suspended in the magnetic gap.

In this embodiment, the main magnetic portion 232 includes a main magnet 2321 stacked and fixed to the lower clamping plate 231, an upper clamping plate 2322 stacked and fixed to a side of the main magnet 2321 away from the lower clamping plate 231, and a central magnet 2323 stacked and fixed to a side of the upper clamping plate 2322 away from the main magnet 2321.

The auxiliary magnetic portion 233 includes an auxiliary magnet 2331 stacked and fixed to the lower clamping plate 231 and spaced apart from the main magnet 2321 to form a magnetic gap, and a magnetic conduction plate 2332 stacked and fixed to a side of the auxiliary magnet 2331 away from the lower clamping plate 231. A side of the first elastic member 4 away from the basket 21 is fixed to a side of the auxiliary magnet 2331 close to the basket 21 or/and a side of the magnetic conduction plate 2332 close to the basket 21.

At least one group of auxiliary magnets 2331 is provided, and each group of auxiliary magnets 2331 includes two auxiliary magnets 2331 which are respectively arranged on two opposite sides of the main magnet 2321.

In this embodiment, two groups of auxiliary magnets 2331 are provided, that is, four auxiliary magnets 2331 are provided and are respectively arranged on four peripheral sides of the main magnet 2321 and spaced apart from each other. Two opposite auxiliary magnets 2331 are stacked and fixed to the lower clamping plate 231. The magnetic conduction plate 2332 is annular and stacked and fixed to a side of the four auxiliary magnets 2331 away from the lower clamping plate 231. The side of the first elastic member 4 away from the basket 21 is fixed to a side of the auxiliary magnets 2331 close to the basket 21 and a side of the magnetic conduction plate 2332 close to the basket 21. The other two opposite auxiliary magnets 2331 are fixed to the magnetic conduction plate 2332, which is equivalent to being indirectly fixed to the basket 21 through the magnetic conduction plate 2332. Two first elastic members 4 are provided and are respectively arranged on two opposite sides of the basket 21, and a side of each first elastic member 4 away from the basket 21 is fixed to the auxiliary magnets 2331 and the magnetic conduction plate 2332.

The first elastic member 4 is made of silicone rubber material or foam material.

The first elastic member 4 is block-shaped, arc-shaped, or bent. The bent shape means that the first elastic member itself includes at least one bend. For example, a cross section of the first elastic member is C-shaped, S-shaped, M-shaped, or N-shaped. According to actual needs, the first elastic member 4 can also be designed in a diamond, oval, trapezoidal, or other shapes. In this embodiment, two first elastic members 4 are provided and are block-shaped.

The multifunctional sound-generating device 100 further includes a fixing member 5 connecting the basket 21 with the first elastic member 4. The fixing member 5 includes a supporting portion 51 fixed to the basket 21 and a bent portion 52 formed by bending and extending from an end of the supporting portion 51 close to the first elastic member 4. The first elastic member 4 is fixed between the auxiliary magnetic portion 233 and the bent portion 52. The design is equivalent to indirectly fixing the side of the first elastic member 4 away from the auxiliary magnetic portion 233 to the basket 21.

At least two fixing members 5 are provided. The multifunctional sound-generating device 100 further includes connecting members 53 connecting adjacent fixing members 5. The connecting members 53 and at least two fixing members 5 form an annular structure, and the magnetic circuit system 23 is arranged in the annular structure. The design can improve the stability of the fixing members 5.

In this embodiment, two fixing members 5 and two connecting members 53 are provided, which means the number of connecting members 53 is the same as the number of fixing members 5. Two ends of each connecting member 53 are respectively connected to ends of the bent portions 52 of the two fixing members 5 on a same side of the magnetic circuit system. According to actual needs, the number of fixing members 5 can also be designed as three, four, five, etc. In addition, the fixing members 5 can also be directly designed as an integrated annular structure.

The multifunctional sound-generating device 100 further includes a first elastic gasket 6 clamped and fixed between a side of the magnetic circuit system 23 away from the vibration system 22 and a side of the housing 1 close to the magnetic circuit system 23. Specifically, the first elastic gasket 6 is clamped and fixed between a side of the lower clamping plate 231 away from the vibration system 22 and a side of the lower cover 12 close to the magnetic circuit system 23. The design can prevent the magnetic circuit system 23 from failing due to dropping. The multifunctional sound-generating device 100 can further include a second elastic gasket 7 clamped and fixed between a side of the vibration system 22 away from the magnetic circuit system 23 and a side of the housing 1 close to the vibration system 22. Specifically, the second elastic gasket 7 is clamped and fixed between a side of the second fixing portion 2215 of the diaphragm 221 away from the magnetic circuit system 23 and a side of the upper cover 11 close to the vibration system 22. The design can further prevent the magnetic circuit system 23 from failing due to dropping. Specifically, the design can prevent the upper cover 11 or the lower cover 12 from being damaged by hard impact when the magnetic circuit system 23 vibrates and strongly impacts the upper cover 11 or the lower cover 12. In addition, the magnetic circuit system squeezes the first elastic gasket and the second elastic gasket when the magnetic circuit system vibrates, thereby improving the reliability of the magnetic circuit system suspended in the housing during vibration and avoiding the possibility of failure due to dropping when the magnetic circuit system vibrates.

The multifunctional sound-generating device 100 further includes a second elastic member 8 elastically supporting the drive coil 3. The second elastic member 8 includes two fixed arms 81 fixed to two opposite sides of the housing 1, a bottom plate 82 suspended on a side of the magnetic circuit system 23 away from the vibration system 22, and two elastic arms 83 respectively extending from the two fixed arms 81 toward two opposite sides of the bottom plate 82 and fixedly connected with the bottom plate 82. The two elastic arms 83 are located on the two opposite sides of the bottom plate 82. In this embodiment, the two fixed arms 81 and the two elastic arms 83 of the second elastic member 8 are located on different sides of the bottom plate 82. The bottom plate 82 is spaced apart from the magnetic circuit system 23 along the first direction. The drive coil 3 is fixed to the bottom plate 82 and is arranged opposite to and spaced apart from the magnetic circuit system 23. The design can stably and elastically support the drive coil 3 in the accommodating space.

The multifunctional sound-generating device 100 further includes a mass block 9 fixed to a side of the bottom plate 82 close to the magnetic circuit system 23. The mass block 9 is spaced apart from the housing 1, the basket 21, and the magnetic circuit system 23 respectively. The design can increase the mass of the bottom plate 82, so as to improve the vibration feeling when the drive coil 3 vibrates.

In this embodiment, two drive coils 3 are provided and are respectively fixed to a side of the bottom plate 82 close to the magnetic circuit system 23. The two drive coils 3 are spaced apart and respectively arranged on two opposite sides of the lower clamping plate 231. Two mass blocks 9 are provided and are respectively arranged on the other two opposite sides of the lower clamping plate 231.

The multifunctional sound-generating device 100 further includes a second flexible circuit board 31, which is electrically connected with the two drive coils 3 respectively and extends outward through the housing 1.

Compared with the related technology, the multifunctional sound-generating device 100 in this embodiment elastically supports the magnetic circuit system 23 on the basket 21 by the first elastic member 4, and limits the moving direction of the magnetic circuit system 23 and the moving direction of the vibration system 22 to be opposite to or away from each other. In this way, when the vibration system 22 vibrates, the bass vibration of the vibration system 22 can be offset by the vibration of the magnetic circuit system 23, thereby reducing the vibration of the basket 21 and the entire machine connected with the basket 21, weakening the vibration feeling during holding or touching the entire machine, and further improving the user experience.

The above are only the embodiments of the present disclosure. It should be pointed out that for those skilled in the art, various improvements can be made without departing from the creative concept of the present disclosure, but all such improvements fall within the protection scope of the present disclosure.

What is claimed is:

1. A multifunctional sound-generating device, comprising a housing with an accommodating space, a sound-generating unit accommodated in the accommodating space, and a drive coil elastically supported in the accommodating space;
wherein the sound-generating unit includes a basket fixed to the housing, a vibration system and a magnetic circuit system respectively located on two opposite sides of the basket, the magnetic circuit system is configured to drive the vibration system to vibrate and generate sound, the vibration system vibrates along a first direction, the drive coil is spaced apart from the magnetic circuit system and located within a magnetic field range of the magnetic circuit system, and the drive coil interacts with the magnetic circuit system to drive the drive coil to move in a plane perpendicular to the first direction;
wherein the magnetic circuit system is spaced apart from the housing, and the multifunctional sound-generating device further comprises a first elastic member elastically supporting the magnetic circuit system to the basket, the first elastic member elastically supports the magnetic circuit system to move along the first direction, and a moving direction of the magnetic circuit system and a moving direction of the vibration system are opposite to each other or away from each other.

2. The multifunctional sound-generating device according to claim 1, wherein the first elastic member is made of silicone rubber material or foam material.

3. The multifunctional sound-generating device according to claim 1, wherein the first elastic member is block-shaped, arc-shaped, or bent.

4. The multifunctional sound-generating device according to claim 1, wherein the magnetic circuit system includes a lower clamping plate, a main magnetic portion stacked and fixed to the lower clamping plate, and an auxiliary magnetic portion stacked and fixed to the lower clamping plate and spaced apart from the main magnetic portion, wherein the first elastic member is fixed between the auxiliary magnetic portion and the basket.

5. The multifunctional sound-generating device according to claim 4, further comprising a fixing member connecting the basket with the first elastic member, wherein the fixing member includes a supporting portion fixed to the basket and a bent portion formed by bending and extending from an end of the supporting portion close to the first elastic member, and the first elastic member is clamped and fixed between the auxiliary magnetic portion and the bent portion.

6. The multifunctional sound-generating device according to claim 5, wherein at least two fixing members are provided, the multifunctional sound-generating device further comprises connecting members connecting adjacent fixing members, the connecting members and at least two fixing members form an annular structure, and the magnetic circuit system is arranged in the annular structure.

7. The multifunctional sound-generating device according to claim 1, further comprising a first elastic gasket clamped and fixed between a side of the magnetic circuit system away from the vibration system and a side of the housing close to the magnetic circuit system.

8. The multifunctional sound-generating device according to claim 7, further comprising a second elastic gasket clamped and fixed between a side of the vibration system away from the magnetic circuit system and a side of the housing close to the vibration system.

9. The multifunctional sound-generating device according to claim 1, further comprising a second elastic member elastically supporting the drive coil, wherein the second elastic member includes two fixed arms fixed to two opposite sides of the housing, a bottom plate suspended on a side of the magnetic circuit system away from the vibration system, and two elastic arms respectively extending from the two fixed arms toward two opposite sides of the bottom plate and fixedly connected with the bottom plate, the bottom plate is spaced apart from the magnetic circuit system along the first direction, and the drive coil is fixed to the bottom plate and arranged opposite to and spaced apart from the magnetic circuit system.

10. The multifunctional sound-generating device according to claim 9, further comprising a mass block fixed to a side of the bottom plate close to the magnetic circuit system, wherein the mass block is spaced apart from the housing, the basket and the magnetic circuit system.
